(19) United States
(12) Patent Application Publication
(10) Pub. No.: US 2009/0309852 A1
(43) Pub. Date: Dec. 17, 2009

(54) TOUCH PANEL INPUT DEVICE AND CONTROL METHOD THEREOF

(75) Inventors: Wei-Po Lin, Taipei (TW); Hung-Yi Lin, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei (TW)

(21) Appl. No.: 12/476,678

(22) Filed: Jun. 2, 2009

(30) Foreign Application Priority Data
Jun. 13, 2008 (TW) 097122221

(51) Int. Cl. G06F 3/045

(52) U.S. Cl. 345/174

(57) ABSTRACT

A touch panel input device includes a touch panel, an analog multiplexer and an embedded controller. The touch panel generates a plurality of analog signals when the touch panel is touched. The analog multiplexer is communicated with the touch panel. The embedded controller is communicated with the analog multiplexer for generating a select signal to the analog multiplexer. The analog multiplexer sequentially outputs one of the analog signals to the embedded controller according to the select signal. The analog signals are converted into corresponding digital signals by the embedded controller.

### FIELD OF THE INVENTION

The present invention relates to a touch panel input device, and more particularly to a touch panel input device having an analog multiplexer and an embedded controller. The present invention also relates to a method of controlling such a touch panel input device.

### BACKGROUND OF THE INVENTION

A touch panel is an input device and a pointing device widely used in a notebook computer. Generally, the touch panel has a specialized touch panel that can translate the motion and the position of a user's fingers to a relative position on a screen. The touch panel may be used as a substitute for a computer mouse if the desk space is scarce. FIG. 1 is a schematic functional block diagram illustrating the connection between a touch panel input device and a host of a notebook computer according to the prior art. The touch panel input device is also referred herein to the touch panel. As shown in FIG. 1, the touch panel input device 1 principally comprises a touch panel 10 and a touch panel controller 11. The touch panel controller 11 is a core component of the touch panel input device 1. The touch panel controller 11 is communicated with the touch panel 10 and a host 12. When the user's finger touches the touch panel 10, the touch panel 10 generates a corresponding analog signal. The touch panel controller 11 can convert the analog signal into a digital signal, retrieve coordinate information from the digital signal, and translate the coordinate information into cursor coordinate information and button information shown on the screen. Via a RS232 or USB interface, the cursor coordinate information and button information is transmitted to the host 12.

The operation principles of the touch panel input device 1 will be illustrated in more details as follows. Typically, the touch panel 10 of the touch panel input device 1 principally comprises a bottom layer of indium tin oxide (ITO) glass and a top layer of indium tin oxide (ITO) conductive film. In addition, many spacer dots are interposed between the ITO glass and the ITO conductive film for isolating the top and bottom layers. The spacer dots may prevent from short circuit if the touch panel 10 is not touched. When a finger, a pen or other object touches the touch panel 10, the conductive coating on the top layer and the coating on the bottom layer are contacted with each other. As such, a voltage which is the analog representation of the touched position is transmitted to the touch panel controller 11. The analog representation of the touched position is then converted into a digital signal by the touch panel controller 11. The coordinate information of the digital signal is transmitted to the host 12. According to the coordinate information, the host 12 may realize the touched position of the touch panel 10. As a consequence, the cursor on the screen will move in both the same direction and at the same speed as the motion of a finger moving on the touch panel's surface.

From the above discussion, the analog representation of the touched position is translated into coordinate information of the digital signal by the touch panel controller 11 and the digital signal is transmitted to the host 12 via a RS232 or USB interface. The use of the touch panel controller 11, however, increases the cost of the touch panel input device 1.

### SUMMARY OF THE INVENTION

In accordance with an aspect, the present invention provides a touch panel input device. The touch panel input device includes a touch panel, an analog multiplexer and an embedded controller. The touch panel generates a plurality of analog signals when the touch panel is touched. The analog multiplexer is communicated with the touch panel. The embedded controller is communicated with the analog multiplexer for generating a select signal to the analog multiplexer. The analog multiplexer sequentially outputs one of the analog signals to the embedded controller according to the select signal. The analog signals are converted into corresponding digital signals by the embedded controller.

In accordance with another aspect, the present invention provides a method for controlling a touch panel input device. The touch panel input device generates a plurality of analog signals when the touch panel input device is touched. The analog signals include a Z-axis pressure value analog signal. The method includes steps of detecting the Z-axis pressure value analog signal, generating a select signal if the magnitude of the Z-axis pressure value analog signal is greater than a threshold value, sequentially outputting one of the analog signals to the embedded controller according to the select signal, and converting the analog signals into corresponding digital signals.

In accordance with a further aspect, the present invention provides a computer system. The computer system includes a touch panel, an analog multiplexer, a host and an embedded controller. The touch panel generates a plurality of analog signals when the touch panel is touched. The analog multiplexer is communicated with the touch panel. The embedded controller is communicated with the analog multiplexer for generating a select signal to the analog multiplexer. The analog multiplexer sequentially outputs one of the analog signals to the embedded controller according to the select signal. The analog signals are converted into corresponding digital signals by the embedded controller. The digital signals are transmitted to the host through a transmission interface.

The present invention provides a touch panel input device having an analog multiplexer and an embedded controller. By cooperating with the embedded controller firmware and the touch panel driver, the analog multiplexer and the embedded controller can replace the touch panel controller. Since the embedded controller is a built-in component of the notebook computer, the touch panel input device of the present invention is more cost-effective.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating the connection between a touch panel input device and a host of a notebook computer according to the prior art;

FIG. 2 is a schematic functional block diagram illustrating the connection between a touch panel input device and a host of a notebook computer according to an embodiment of the present invention;

FIG. 3 is a schematic circuit diagram illustrating the touch panel input device of the present invention;

FIG. 4 is a truth table listing the relations between all possible select signal combinations and their corresponding analog signals as shown in FIG. 3; and

FIG. 5 is a flowchart illustrating a method of controlling the touch panel input device of the present invention.

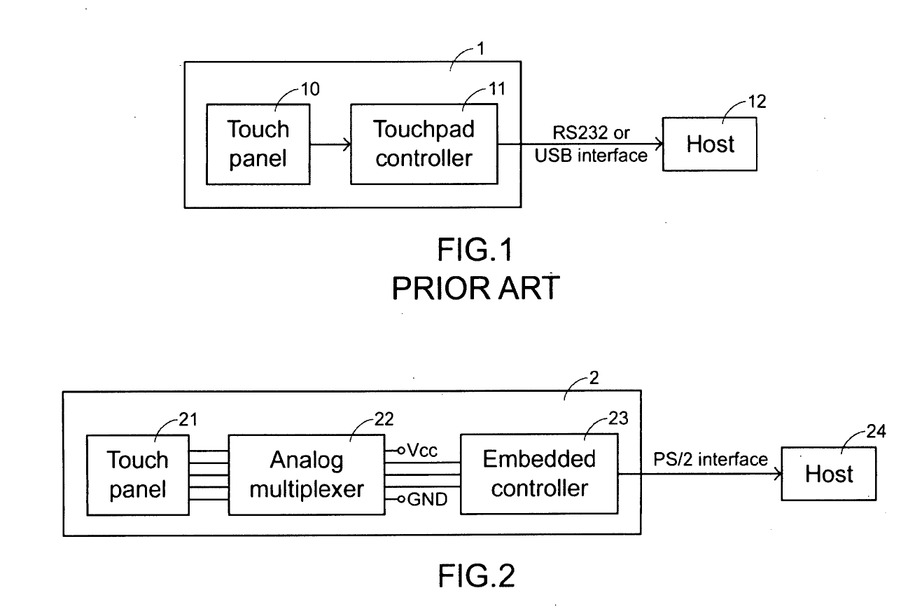

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

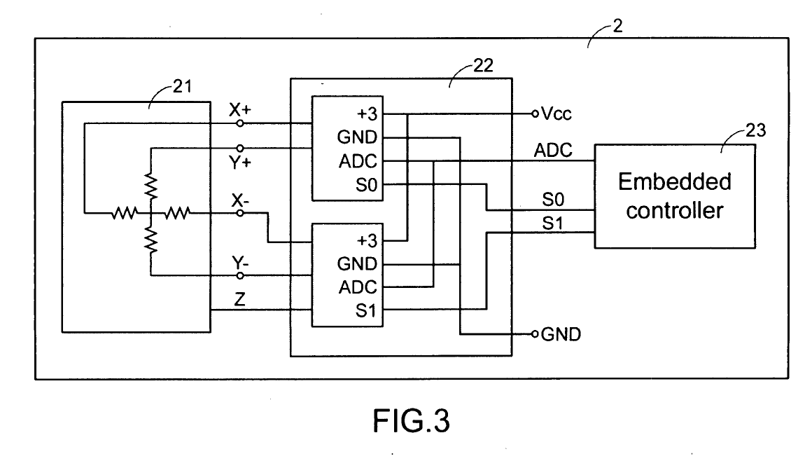

FIG. 2 is a schematic functional block diagram illustrating the connection between a touch panel input device and a host of a notebook computer according to an embodiment of the present invention. As shown in FIG. 2, the touch panel input device 2 principally comprises a touch panel 21, an analog multiplexer 22 and an embedded controller 23. A first terminal of the analog multiplexer 22 is communicated with the touch panel 21. A second terminal of the analog multiplexer 22 is communicated with the embedded controller 23. When the touch panel 21 is touched by a user's finger, the touch panel 21 generates a plurality of analog signals. These analog signals include at least an X-axis analog signal, a Y-axis analog signal and a Z-axis pressure value analog signal. According to a select signal (S0, S1) (see FIG. 3) issued by the embedded controller 23, the analog multiplexer 22 sequentially outputs one of the analog signals. In this embodiment, the embedded controller 23 issues the select signal if the magnitude of the Z-axis pressure value analog signal outputted from the analog multiplexer 22 is greater than a threshold value. After the select signal is received by the analog multiplexer 22, the analog multiplexer 22 sequentially outputs one of the analog signals.

The embedded controller 23 is used to control the analog multiplexer 22 to select the analog signals generated by the touch panel 21. In addition, after the analog signals are received by the embedded controller 23, the embedded controller 23 will convert the analog signals into corresponding digital signals. First of all, the Z-axis pressure value analog signal is continuously detected by the embedded controller 23. When the touch panel 21 is touched by a user's finger, the Z-axis pressure value analog signal is subject to a variation. If the magnitude of the Z-axis pressure value analog signal is greater than a threshold value, it is meant that the touch panel 21 is touched by an object. At this time, the embedded controller 23 sequentially switches the select signal, and receives the X-axis analog signal, the Y-axis analog signal and the Z-axis pressure value analog signal. On the other hand, if the magnitude of the Z-axis pressure value analog signal is not greater than the threshold value, the embedded controller 23 only receives the Z-axis pressure value analog signal.

After the X-axis analog signal, the Y-axis analog signal and the Z-axis pressure value analog signal are received and respectively converted into the X-axis digital signal, the Y-axis digital signal and the Z-axis pressure value digital signal by the embedded controller 23, these digital signals are transmitted from an embedded controller firmware of the embedded controller 23 to a host 24 through a PS/2 interface. In other words, these digital signals are transmitted from the embedded controller firmware to the host 24 through the PS/2 interface according to a specified protocol. By a touch panel driver and a coordinate correction program, these digital signals are translated into corresponding cursor coordinate information and button information. The principle of translating these digital signals into corresponding cursor coordinate information and button information will be illustrated in more details as follows.

FIG. 3 is a schematic circuit diagram illustrating the touch panel input device of the present invention. The touch panel 21 is a resistive touch panel such as a four-wire, five-wire or eight-wire resistive touch panel. The operation principles of the four-wire resistive touch panel, the five-wire resistive touch panel and the eight-wire resistive touch panel are somewhat different. In this embodiment, the touch panel 21 is four-wire resistive touch panel. The four-wire resistive touch panel 21 includes an X+ terminal, an X− terminal, a Y+ terminal and a Y− terminal. By detecting the signals outputted from the X+ terminal, the X− terminal, the Y+ terminal and the Y− terminal, the X-axis coordinate and the Y-axis coordinate of the touched position of the user's finger is recognized. In other words, when a finger, a pen or other object touches the four-wire resistive touch panel 21, the conductive coating on the top layer and the coating on the bottom layer of the four-wire resistive touch panel 21 are contacted with each other and generate a voltage.

The analog multiplexer 22 is connected to a source voltage Vcc (e.g. 3V) and a ground end GND. The select signal is outputted from two select ends S0 and S1 of the embedded controller 23. According to the level statuses of the select ends S0 and S1 of the select signal, the analog multiplexer 22 sequentially outputs one of the analog signals. Moreover, according to the select signal, the two analog multiplexing circuits of the analog multiplexer 22 allow the source voltage Vcc or the ground end GND to be connected to different terminals of the touch panel 21.

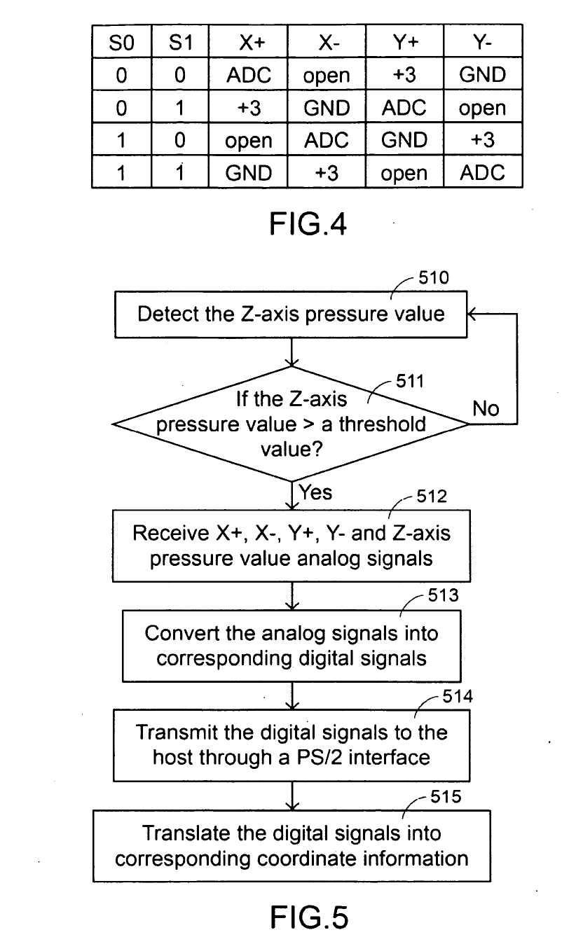

FIG. 4 is a truth table listing the relations between all possible select signal combinations and their corresponding analog signals as shown in FIG. 3. According to the select signal (S0, S1) issued by the embedded controller 23, the analog multiplexer 22 sequentially outputs one of the analog signals to the embedded controller 23. The selected analog signal is transmitted to the ADC pin of the embedded controller 23 through the output end of the analog multiplexer 22.

For example, according to the select signal (S0, S1)=(0, 0), the Y+ terminal is connected to the 3V source voltage Vcc, the Y− terminal is connected to the ground end GND, the X− terminal is opened, and the X+ terminal is connected to the ADC pin of the embedded controller 23, so that the X+ analog signal is transmitted to the embedded controller 23. According to the select signal (S0, S1)=(0, 1), the X+ terminal is connected to the 3V source voltage Vcc, the X− terminal is connected to the ground end GND, the Y− terminal is opened, and the Y+ terminal is connected to the ADC pin of the embedded controller 23, so that the Y+ analog signal is transmitted to the embedded controller 23. According to the select signal (S0, S1)=(1, 0), the Y− terminal is connected to the 3V source voltage Vcc, the Y+ terminal is connected to the ground end GND, the X+ terminal is opened, and the X− terminal is connected to the ADC pin of the embedded controller 23, so that the X− analog signal is transmitted to the embedded controller 23. According to the select signal (S0, S1)=(0, 1), the X− terminal is connected to the 3V source voltage Vcc, the X+ terminal is connected to the ground end GND, the Y+ terminal is opened, and the Y− terminal is connected to the ADC pin of the embedded controller 23, so that the Y− analog signal is transmitted to the embedded controller 23.

In other words, according to the select signal (S0, S1) issued by the embedded controller 23, the analog multiplexer 22 sequentially outputs the X+ analog signal, the X− analog signal, the Y+ analog signal and the Y− analog signal. These analog signals are then converted into corresponding digital signals by the analog-to-digital converting circuit (not shown) of the embedded controller 23.

FIG. 5 is a flowchart illustrating a method of controlling the touch panel input device of the present invention. After the touch panel input device is activated, the Z-axis pressure value analog signal is continuously detected by the embedded controller 23 (Step 510). Next, the embedded controller 23 discriminates whether the magnitude of the Z-axis pressure value analog signal is greater than a threshold value (Step 511). If the magnitude of the Z-axis pressure value analog signal is not greater than the threshold value, the Z-axis pressure value analog signal is continuously detected by the embedded controller 23 (Step 510). Whereas, if the magnitude of the Z-axis pressure value analog signal is greater than the threshold value (Step 511), it is meant that the touch panel 21 is touched by an object and the Step 512 is done. In the Step 512, the embedded controller 23 sequentially switches the select signal. According to the select signal, the analog multiplexer 22 sequentially outputs the X+ analog signal, the X− analog signal, the Y+ analog signal, the Y− analog signal and the Z-axis pressure value analog signal to the embedded controller 23. Next, the X+ analog signal, the X− analog signal, the Y+ analog signal, the Y− analog signal and the Z-axis pressure value analog signal are respectively converted into an X+ digital signal, an X− digital signal, a Y+ digital signal, a Y− digital signal and a Z-axis pressure value digital signal (Step 513). Next, these digital signals are transmitted from an embedded controller firmware of the embedded controller 23 to the host 24 through a PS/2 interface (Step 514). By a touch panel driver and a coordinate correction program installed in the host 24, these digital signals are translated into corresponding cursor coordinate information and button information (Step 515).

From the above description, the touch panel input device of the present invention includes an analog multiplexer and an embedded controller. By cooperating with the embedded controller firmware and the touch panel driver, the analog multiplexer and the embedded controller can replace the touch panel controller. Since the embedded controller is a built-in component of the notebook computer, the touch panel input device of the present invention is more cost-effective.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch panel input device comprising:
a touch panel generating a plurality of analog signals when the touch panel is touched;
an analog multiplexer communicated with the touch panel; and
an embedded controller communicated with the analog multiplexer for generating a select signal to the analog multiplexer, wherein the analog multiplexer sequentially outputs one of the analog signals to the embedded controller according to the select signal, and the analog signals are converted into corresponding digital signals by the embedded controller.

2. The touch panel input device according to claim 1 wherein the analog signals include a Z-axis pressure value analog signal, and if the magnitude of the Z-axis pressure value analog signal is greater than a threshold value, the embedded controller generates the select signal to the analog multiplexer, so that the analog multiplexer sequentially outputs one of the analog signals to the embedded controller according to the select signal.

3. The touch panel input device according to claim 1 wherein the select signal is outputted from two select ends of the embedded controller, and the level statuses of the select ends are sequentially switched such that the analog multiplexer sequentially outputs one of the analog signals to the embedded controller.

4. The touch panel input device according to claim 1 wherein the analog signals include an X+ analog signal, an X− analog signal, a Y+ analog signal, a Y− analog signal and a Z-axis pressure value analog signal, and the digital signals include an X+ digital signal, an X− digital signal, a Y+ digital signal, a Y− digital signal and a Z-axis pressure value digital signal.

5. The touch panel input device according to claim 1 wherein the embedded controller includes an embedded controller firmware, and the embedded controller firmware transmits the digital signals to a host through a PS/2 interface.

6. The touch panel input device according to claim 1 wherein the touch panel is a four-wire resistive touch panel, a five-wire resistive touch panel or an eight-wire resistive touch panel.

7. A method for controlling a touch panel input device, the touch panel input device generating a plurality of analog signals when the touch panel input device is touched, the analog signals including a Z-axis pressure value analog signal, the method comprising steps:
detecting the Z-axis pressure value analog signal;
generating a select signal if the magnitude of the Z-axis pressure value analog signal is greater than a threshold value;
sequentially outputting one of the analog signals to the embedded controller according to the select signal; and
converting the analog signals into corresponding digital signals.

8. The method according to claim 7 wherein the digital signals are transmitted to a host through a PS/2 interface.

9. The method according to claim 8 wherein the digital signals are translated into corresponding coordinate information by a touch panel driver and a coordinate correction program.

10. The method according to claim 9 wherein the coordinate information includes cursor coordinate information and button information.

11. The method according to claim 7 wherein the analog signals include an X+ analog signal, an X− analog signal, a Y+ analog signal, a Y− analog signal and a Z-axis pressure value analog signal, and the digital signals include an X+ digital signal, an X− digital signal, a Y+ digital signal, a Y− digital signal and a Z-axis pressure value digital signal.

12. A computer system comprising:
a touch panel generating a plurality of analog signals when the touch panel is touched;
an analog multiplexer communicated with the touch panel;
a host; and
an embedded controller communicated with the analog multiplexer for generating a select signal to the analog multiplexer, wherein the analog multiplexer sequentially outputs one of the analog signals to the embedded controller according to the select signal, the analog signals are converted into corresponding digital signals by the embedded controller, and the digital signals are transmitted to the host through a transmission interface.

13. The computer system according to claim 12 wherein the digital signals are translated into corresponding coordinate information by a touch panel driver and a coordinate correction program of the host.

14. The computer system according to claim 13 wherein the coordinate information includes cursor coordinate information and button information.

15. The computer system according to claim 12 wherein the transmission interface is a PS/2 interface.

16. The computer system according to claim 12 wherein the select signal is outputted from two select ends of the embedded controller, and the level statuses of the select ends are sequentially switched such that the analog multiplexer sequentially outputs one of the analog signals to the embedded controller.
